(19) United States
(12) Patent Application Publication
(10) Pub. No.: US 2024/0204810 A1
(43) Pub. Date: Jun. 20, 2024

(54) SYSTEM AND METHOD FOR RECEIVING PHASE-SHIFT KEYED AND AMPLITUDE-PHASE MODULATED SIGNALS

(71) Applicant: Joseph Brifman, Flagler Beach, FL (US)

(72) Inventor: Joseph Brifman, Flagler Beach, FL (US)

(21) Appl. No.: 18/526,277

(22) Filed: Dec. 1, 2023

Related U.S. Application Data
(60) Provisional application No. 63/429,767, filed on Dec. 2, 2022.

(51) Int. Cl. H04B 1/10

(52) U.S. Cl. CPC H04B 1/10

(57) ABSTRACT

A system and method for achieving a clean separation of signal and noise and receiving phase-shift keyed and amplitude-phase modulated signals. The system comprises a frequency selective filter to preliminary process a signal-to-noise mixture and a calculator-solver for separation signal and noise. The system is configured to provide an almost absolute cleaning phase-shift keyed signals from additive noises. The system allows for the realization of data transmission at extremely low signal-to-noise ratios and achieves data transfer rates which significantly exceeds existing Capacity limits. At the same time the reliability of communication can be provided arbitrary high.

### CROSS-REFERENCE TO RELATED APPLICATION

The present application claims priority to, and the benefit of, U.S. Provisional Application No. 63/429,767, which was filed on Dec. 2, 2022 and is incorporated herein by reference in its entirety.

### BACKGROUND

The present invention generally relates to a system for improving the transmission of information, and more specifically to systems and methods of improving the reception of phase-shift keyed and amplitude-phase modulated signals. Accordingly, the present specification makes specific reference thereto. However, it is to be appreciated that aspects of the present invention are also equally amenable to other like applications, devices, and methods of manufacture.

The main problem for fast and reliable transmission of information over real wired and radio channels is the presence of interference or noise. The nature of the interference occurrence is subject to many variables. However, such noise is always present and interferes with the transmission of information. The achievable speed of absolutely error-free transmission in an idealized channel without interference has no limits and is determined only by the performance of the information source. Unfortunately, due to noise occurrences, existing communication systems are much slower, and errors are observed at the output of data receivers. Therefore, a system for the transmission of information, which use phase-shift keying (PSK) and amplitude-phase

modulated (APSK) signals is desired. Therefore, a system for the transmission of information, which use phase-shift keying (PSK) and amplitude-phase modulated (APSK) signals is desired, always has characteristics that are significant worse than we expect.

A universal description of signals can be represented as follows. The transmitted signal S(t) is a sum of two quadrature-coupled harmonic oscillations (sine and cosine):

$$\begin{matrix}xc ( t ) = cos ( 2 π {F}_{C} t + {φ}_{0} ) \\ xs ( t ) = sin ( 2 π {F}_{C} t + {φ}_{0} )\end{matrix} \} \{ \begin{matrix}t ∈ {T}_{S} - signal duration \\ {F}_{C} - carrier frequency \\ {φ}_{0} - initial phase\end{matrix} \} \\ S ( t ) = a \cdot xc ( t ) + b \cdot xs ( t ) , \qquad Equation ( 1 )$$

where, a, b are amplitude coefficients.

For the formation of PSK signals, the following condition must be met:

(a²+b²)=Const. Equation (2)

It is then possible to determine energy characteristics of the PSK signal. Signal energy at F_{C}>>0 can be calculated via the following:

$$\begin{matrix}{E}_{S} = \frac{1}{2} {\int }_{0}^{{T}_{S}} ( {a}^{2} + {b}^{2} ) dt & Equation ( 3 ) \\ {E}_{b} = \frac{{E}_{S}}{Nb} , & Equation ( 4 )\end{matrix}$$

where Nb=log₂m is the number of bits transmitted by the signal in one modulation interval. E_{b} is energy, spent to one transmitted bit; m is the number of phase angles or signal point on the phase plan which is used. If m>2, then Gray coding is typically used to map phase angles to combinations of blocks of binary numbers. To image the PSK structure, is convenient to use phase plans and signals points. FIG. 1 shows some examples of phase plane representation and mapping to bit blocks for PSK-2 (BPSK), PSK-4 and PSK-16.

For generating volumetric styling APSK signals parameters a and b take equally spaced values from ranges [aₘᵢₙ, aₘₐₓ] and [bₘᵢₙ, bₘₐₓ] respectively. The possible example of square APSK ensemble at m=256 is shown in the FIG. 2. To satisfy the same energy condition as in FIG. 1 E_{b}=1 the boundaries of the quadrature ranges of coefficients must be selected as follows:

$${a}_{max} = {b}_{max} = - {a}_{min} = - {b}_{min} = \sqrt{\frac{2 \cdot m \cdot Nb \cdot {E}_{b}}{{\sum }_{i = 0}^{15} {\sum }_{k = 0}^{15} {[ ( 1 - \frac{2 \cdot i}{\sqrt{m} - 1} ) + ( 1 - \frac{2 \cdot i}{\sqrt{m} - 1} ) ]}^{2}}} \approx 3.254 \qquad Equation ( 5 )$$

The smallest distance between adjacent signal points for the ensemble in FIG. 2 is determined as follows:

$$Δ = \frac{{a}_{max} - {a}_{min}}{\sqrt{m} - 1} = \frac{{b}_{max} - {b}_{min}}{\sqrt{m} - 1} \approx 0.434 \qquad Equation ( 6 )$$

In the Gaussian channel with additive white gaussian noise (AWGN) the signal PSK or APSK S(t) described with the help model of Equation (1) additive mixtures with the noise N(t). Theoretically, noise can have unlimited bandwidth and be characterized by spectral power noise density No is the noise power, which concentrated in the one Hertz of the frequency band. The follows mixture is observed at the channel output:

$$Y ( t ) = S ( t ) + N ( t ) = \underbrace{aq \cdot xc ( t ) + b \cdot xs ( t )}_{PSK or APSK signal} + N ( t ) \qquad Equation ( 7 )$$

To define the N(t) next decomposition may be used:

$$N ( t ) = {\sum }_{i = TN \cdot FL}^{TN \cdot FH} [ {nc}_{i} cos ( 2 π \frac{i}{TN} t ) + {ns}_{i} sin ( 2 π \frac{i}{TN} t ) ] \qquad Equation ( 8 )$$

This expression represents Gaussian noise as a sum of large number of harmonic oscillations with random amplitudes. In this formula TN denotes period of the noise decomposition, which can be more than signal durations (to avoid singularity of the channel model). ncᵢ, nsᵢ are normally distributed random values with zero mean and standard deviation n0. For a given signal-to-noise ratio

$${h}_{n} = \frac{{E}_{b}}{No} ,$$

the value of the n0 can be calculated as follows:

$$n 0 = \sqrt{\frac{{E}_{b}}{Nb \cdot TN \cdot {h}_{n}}} \qquad Equation ( 9 )$$

Where Nb is the number of bits, which transmitted by single signal on the one modulation interval. For example, for PSK-2 (BPSK) Nb =1, for PSK-4 Nb=4, for PSK-16 Nb=4, for APSK-256 Nb=8. In Equation (8) FL, FH denotes the lowest and the highest frequencies in the noise spectrum. This is the best existing receiving method for reception implementation under AWGN conditions.

This method and devices implemented are the analog to the current invention since the same common reception conditions are assumed. Namely, it is assumed that synchronization problem is solved and we know exactly the moment of the beginning of the signal and completely correctly restore the carrier frequency. The OCR method is based on the quadrature reception i.e., on the calculation of the quadrature amplitude coefficients of the signal components. In FIG. 3 the scheme of OCR method is shown. Since this method itself has filtering properties (due to the use of the correlation integral) there is no need for additional frequency selective filters, which can't improve final result. The quadrature demodulator performs calculation of estimations quadrature coefficients a′, b′ on the time interval of the signal existence T_{S}:

$${a}^{′} = \frac{2}{{T}_{S}} {\int }_{0}^{{T}_{S}} Y ( t ) \cdot xc ( t ) dt , {a}^{′} = \frac{2}{{T}_{S}} {\int }_{0}^{{T}_{S}} Y ( t ) \cdot xs ( t ) dt \qquad Equation ( 10 )$$

These estimations are the coordinates of the received signal point on the phase plane. The comparator finds the distances from this point to the allowed points of the used ensemble and decides on the value of the received block of bits.

In an analysis of the results OCR using for PSK-4, the next channel conditions are used: signal-to-noise ratio

$${h}_{n} = \frac{{E}_{b}}{No} = 0.1$$

(this is a very bad channel, the extremely hard transfer conditions); signal's parameters: T_{S}=0.1 [s.]; F_{C}=20 [Hz];

$${φ}_{0} = \frac{π}{10} ;$$

bits block “00”, transmitted signal point is situated in the 1st quadrant of the phase plan (see FIG. 1.); noise's parameters: TN=3 [s.]; FL=0; FH=1000 [Hz]. Noise's frequency bandwidth is a lot more than signal frequency bandwidth.

Under the conditions above, the simplest rule to make a decision about value of receiving double bit is analyses of a quadrant number on the phase plane where is situated point with coordinates a′, b′. This rule can be described in the next manner:

a′>0, b′>0⇒1 quadrant⇒bits block “00”;

a′<0, b′>0⇒3 quadrant⇒bits block “11”;

a′<0, b′<0⇒2 quadrant⇒bits block “10”;

a′>0, b′<0⇒4 quadrant⇒bits block “01”; Equation (11)

The results of the OCR statistical testing are illustrated in FIG. 4, which shows the distribution of OCR-recovered received points, when transmitting a block “00” bits under the various noise implementations. The scope of the experiment was the transmission of N_{BS}=2000 binary symbols (1000 realizations of the PSK-4 signals). Obviously, hard condition hₙ=0.1 leads to the very poor results. Received signal points estimations far scattered from the true signal point. For any other point of PSK-4 ensemble the result is similar. There is a probabilistic indicator of reliability communication as Bit Error Rate (BER). This indicator defines probability of the error that occurrences in the single binary symbol at the OCR receiver output. To calculate BER_{OCR} (for the results in the FIG. 1, the formula, based on the rules in Equation (11) must be used:

$${BER}_{OCR} = \frac{n 2 + n 4 + 2 \cdot n 3}{{N}_{BS}} = \frac{n 2 + n 4 + 2 \cdot n 3}{2000} \qquad Equation ( 12 )$$

where n2 and n4] are quantities of points, which according to OCR rule of reception got into 2nd and 4th quadrants of the phase plane when erroneous is only one symbol from two transmitted. n3 is a quantity of points which got into 3rd quadrant, when erroneous are both transmitted symbols. For the result as shown in FIG. 1,

BER_{OCR PSK-4}≈0.333 Equation (13)
Such value says that with signal-to-noise ratio hₙ=0.1, on average, every third binary symbol is received according to the OCP rule with an error. This result fully agrees with the well-known estimates.

Accordingly, there is a great need for a way to separate a signal and noise in phase-shift keyed and amplitude-phase modulated signals. There is also a need for reliable and high-speed communication for the most common classes of real signals with phase and amplitude phase modulation. In this manner, the improved transmission system of the present invention accomplishes all of the forgoing objectives, thereby providing a solution for improving the characteristics of information transmission systems in terms of providing the absolutely accurate separation of signals and noise in phase-shift keyed and amplitude-phase modulated signals.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a system for achieving a signal and noise separation in phase-shift keyed and amplitude-phase modulated signals. The system comprises a linear analog filter. The linear analog filter comprises a low pass filter (LPF), a band pass filter (BPF) 114, or both. A low-pass filter is a circuit that only passes signals below its cutoff frequency while attenuating all signals above it. A band pass filter works to screen out frequencies that are too low or too high, giving easy passage only to frequencies within a certain range. The main task of the linear analog filter is the preliminary limit of the spectrum of noise which is mixtured with a signal.

The system further comprises an analog to digital converter (ADC) and a solver-separator component in communication with the linear analog filter. The analog to digital converter is configured to accept a signal to noise mixture from a transmitter/modulator via a channel with noise and send a modified signal to noise mixture to the solver-separator component for completing the clean separation of signal and noise. The solver-separator component is configured to solve a system of linear algebraic equations based on a linear separating matrix (LSM).

The subject matter disclosed and claimed herein, in another embodiment thereof, comprises a method of achieving a clean signal and noise separation in phase-shift keyed and amplitude-phase modulated signals using the system. The method begins by providing a phase-shift keyed and amplitude-phase modulated signals with Gaussian channel noise from a Gaussian channel output. The noise enters a linear analog filter where the spectrum of noise is suppressed. Then a signal-noise mixture is quantized using an analog to digital converter. A modified signal to noise mixture is then sent to a solver-separator component. The solver-separator component uses discrete measurements of the modified signal to noise mixture are used to build a system of linear algebraic equations. Finally, a linear separating matrix of coefficients is used to achieve a clean separation of signal and noise. Out-of-band noise frequencies may also be suppressed prior to entering the linear analog filter.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an illustration of phase plans of PSK signals for the equal energy conditions in accordance with the disclosed architecture.

FIG. 2 illustrates an example of phase plans of APSK-256 signal for the equal energy conditions in accordance with the disclosed architecture.

FIG. 3 illustrates an illustrative embodiment of a scheme for an OCR method in accordance with the disclosed architecture.

FIG. 4 illustrates a graph of results of a statistical testing OCR method for PSK-4 signal in accordance with the disclosed architecture.

FIG. 5 illustrates an illustrative embodiment of a system for achieving a PSK and APSK signal and noise separation (SNS) of the present invention in accordance with the disclosed architecture.

FIG. 6 illustrates a linear separating matrix of the present invention in accordance with the disclosed architecture.

FIG. 7 illustrates a graph illustrating a frequency response of the LPF of the present invention in accordance with the disclosed architecture.

FIG. 8 illustrates a graph illustrating transformations of PSK, APSK signals quadrature components after pre-filtering of the present invention in accordance with the disclosed architecture.

FIG. 9 illustrates a graph illustrating PSK-4 signal and noise realization after pre-filtering by LPF of the present invention in accordance with the disclosed architecture.

FIG. 10 illustrates a graph illustrating results of the statistical testing developed SNS-method for PSK-4 processing of the present invention in accordance with the disclosed architecture.

FIG. 11 illustrates a graph illustrating results of the statistical testing developed SNS-method for PSK-16 of the present invention in accordance with the disclosed architecture.

FIG. 12 illustrates a graph illustrating frequency response of the BPF of the present invention in accordance with the disclosed architecture.

FIG. 13 illustrates a graph illustrating results of BPF conversions of the quadrature components of the AFSK-256 signal of the present invention in accordance with the disclosed architecture.

FIG. 14 illustrates a graph illustrating noise N(t) and signal AFSK-256 form factor xc(t)+xs(t) pre-filtering BPF of the present invention in accordance with the disclosed architecture.

FIG. 15 illustrates a graph illustrating results of the statistical testing of the APSK-256 signal when the S/N ratio is

$${h}_{n} = \frac{{E}_{b}}{No} = 0.1$$

of the present invention in accordance with the disclosed architecture.

FIG. 16 illustrates a graph illustrating SNS-method advantages when using the system for achieving a PSK and APSK signal and noise separation of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a system and method for receiving phase-shift keyed and amplitude-phase modulated signals. The invention relates to telecommunication systems, which provide information transfer at rates exceeding the Shannon's Capacity. The system employs a frequency selective filter to preliminary process a signal-to-noise mixture, analog to digital converter and special calculator-solver for separation signal and noise. The system and method for its implementing provide almost absolute cleaning phase-shift keyed signals from additive noises. This allows for the realization of data transmission at extremely low signal-to-noise ratios and achieves data transfer rates which significantly exceed existing now Capacity limits. At the same time, the reliability of communication can be provided arbitrary high.

A separation of signal and noise can be achieved under a process for recovering of the square pulse amplitude under additive gaussian noise by analog and digital filtering and the implementation of algebraic separation of impulse and noise realization by constructing the most similar noise decomposition. Noise can be an interference in a channel or a communication line. The main disadvantage and limitation of the method is the use of processing operations, that are suitable only for rectangular elementary pulses. Such signals are not used in the real communications. As a consequence, the linear separating matrix of the algebraic solver has an incomplete structure. This fact does not allow us to apply prototype for real signals processing.

The main purpose of this invention is the development and proof of the exceptional efficiency (compared to analogues) of a new system and method for separating noise and signal (SNS-method), used for PSK and APSK signal systems. Thus, the problem of reliable and high-speed communication is solved for the most common classes of real signals with phase and amplitude phase modulation.

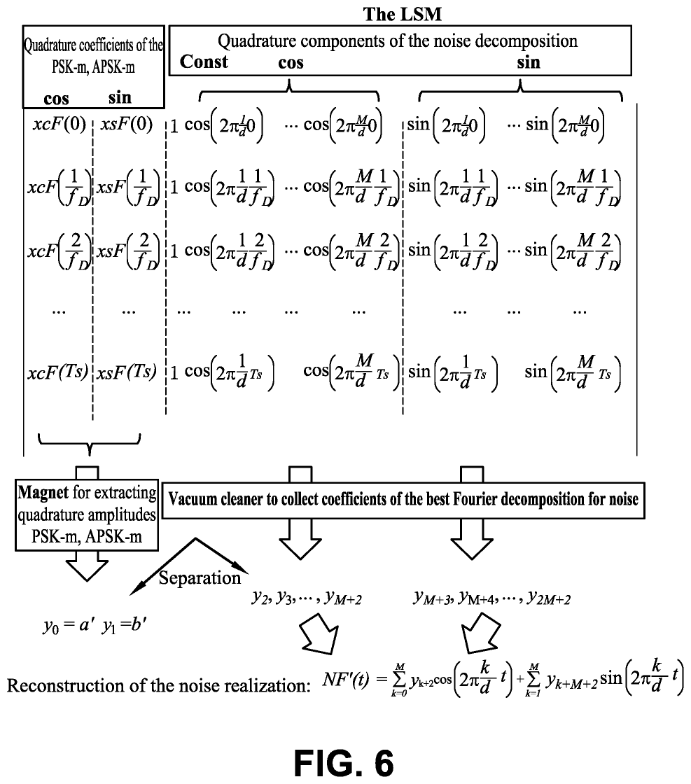

The present invention, in one exemplary embodiment as illustrated in FIG. 5 comprises a system in the FIG. 6 configured to separate signals by their known form factors against the background of additive random noise implementations using digital algebraic system. This system does not have a filtering property, as is observed in the OCR technology when calculating the correlation integrals. So, when noise bandwidth is very large to limit it, preliminary filtering is needed.

The system, shown in FIG. 6, comprises a linear analog filter. The linear analog filter comprises a low pass filter (LPF), a band pass filter (BPF), or both. A low-pass filter is a circuit that only passes signals below its cutoff frequency while attenuating all signals above it. A band pass filter works to screen out frequencies that are too low or too high, giving easy passage only to frequencies within a certain range. The main task of the linear analog filter is the preliminary limit of the spectrum of noise which is mixtured with a signal.

The system of the SLAE further comprises an analog to digital converter (ADC) and a solver-separator component in communication with the linear analog filter. The analog to digital converter is configured to accept a signal to noise mixture from a transmitter/modulator via a channel with noise and send a modified signal to noise mixture to the solver-separator component for completing the clean separation of signal and noise. The solver-separator component is configured to solve a system of linear algebraic equations based on a linear separating matrix (LSM).

A method of achieving a clean signal and noise separation in phase-shift keyed and amplitude-phase modulated signals using the system SLAE comprises providing a phase-shift keyed and amplitude-phase modulated signals with Gaussian channel noise from a Gaussian channel output. The noise enters a linear analog filter where the spectrum of noise is suppressed. Then a signal-noise mixture is quantized using an analog to digital converter. A modified signal to noise mixture is then sent to a solver-separator component. The solver-separator component uses discrete measurements of the modified signal to noise mixture are used to build a system of linear algebraic equations. Finally, a linear separating matrix of coefficients is used to achieve a clean separation of signal and noise. Out-of-band noise frequencies may also be suppressed prior to entering the linear analog filter.

The fundamental difference between OCR-analog and the proposed SNS method is their different sensitivity with respect to the spectrum bands of the influencing noise. The most dangerous frequencies for the OCR-method are the in-band components located in the signal frequency band. On the contrary, for the SNS-method out-of-band noises (the spectrum of which is located outside the effective frequency band of the signal) are especially harmful. Their presence leading to an unacceptable increase in computational complexity of the solvers task. It is not difficult to suppress such noises. Exactly for this purpose the SLAE uses the linear analog filtering. However, changes of the signal form-factor must still be accounted for. It is important to note, when a noise has strictly or effectively width-limited spectrum, then there isn't need use a filtering. In this case the effectiveness of the SNS-method is significantly higher.

The SNS scheme shown in the FIG. 5 which includes LPF and BPF is intended for the case of the presence noise with unlimited spectrum, or Additive White Gaussian Noise (AWGN). Pre-filtering results in the suppression of out-of-band noise frequencies and some changes in the signal form factor Y(t)⇒YF (t):

YF(t)=SF(t)+NF(t) Equation (14)

In accordance of the scheme illustrated in FIG. 5, the next operation after pre-filtering is sampling and quantizing signal-noise mixture using Equation (14) by the Analog to Digital Converter (ADC). The ADC digitizes the filter mixture at a sampling rate f_{D} per second. The simplest and absolutely correct description of the ADC conversion for one sample can be obtained by following expression:

$$YFq ( t ) = \frac{D}{{2}^{nb - 1}} \cdot round ( YF ( t ) / \frac{D}{{2}^{nb - 1}} ) \qquad Equation ( 15 )$$

where nb is bit dept of ADC; Dis a half (unsigned) of the dynamic range at the ADC input; and round( ) is the function of arithmetic rounding to the nearest integer.

After digitizing with the algebraic solver (specialized microcontroller or computer), the SLAE for receiving PSK, APSK signals is directly implemented by special software. Based on the flow of ADC measurement samples, the separator-solver 130 builds a special system of linear algebraic equations (SLAE)

A·y=B. Equation (16)

Where A is the Linear Separating Matrix of coefficients at the desired variables, and B is the vector (one dimensional array) of ADC samples, which is the set of equations free terms.

To construct the SLAE Equation (15) for each of sampling moment τᵢ solver constructs the equation:

$${y}_{0} \cdot xcF ( {τ}_{i} ) + {y}_{1} xsF ( {τ}_{i} ) ++ {y}_{2} \cdot cos ( 2 π \frac{0}{d} {τ}_{i} ) + {y}_{3} \cdot cos ( 2 π \frac{1}{d} {τ}_{i} ) + … + {y}_{M + 2} \cdot cos ( 2 π \frac{M}{d} {τ}_{i} ) + {y}_{M + 3} \cdot sin ( 2 π \frac{1}{d} {τ}_{i} ) + {y}_{M + 4} \cdot sin ( 2 π \frac{2}{d} {τ}_{i} ) + … + {y}_{2 M + 2} \cdot cos ( 2 π \frac{M}{d} {τ}_{i} ) = {B}_{i} ; \qquad Equation ( 17 )$$

$${B}_{i} = YF ( {τ}_{i} ) ; i ∈ 0 … {T}_{S} \cdot {f}_{D} .$$

Here y₀=a′ and y₁=b′ are desired amplitude coefficients of the quadrature components of the y PSK-m or APSK-m signal. These values determine evaluations of the coordinates of signal point on the phase plane and there are the base for deciding on the block of bit. The variables y₂, y₃, . . . y_{2M+2} are desired coefficients of harmonic Fourier decomposition of noise realization observed by receiver. And y₂, y₃, . . . y_{M+2} are the coefficients of cos -quadratures with frequencies from 0 to M/d HZ, y_{M+3}, yₘ₊₄, . . . y_{2M+2} are the coefficients of sin-quadratures with d frequencies from 1/d to M/d Hz. When constructing the decomposition, we assume that after the preliminary filtering of the signal-noise mixture, the noise implementation does not contain frequencies higher than M/d Hz. So, the mathematical and physical sense of the parameter M is M=d·Fₕ where Fₕ is the highest frequency, which can be observed in the noise spectrum after pre-filtering. The d Parameter has the meaning of the period of the best decomposition of the noise realization on the interval of the signal existence. To avoid influence of Gibbs effect at the ends of the decomposition time interval, the period d should be longer than T_{S}: d>T_{S}. Usually, value d=(1.1÷1.5)T_{S} is enough.

It is important, to achieve the best result of the recovering signal PSK or APSK, system (16) must be overdetermined, that is number of equations have to be greater than number of the desired variables: T_{S}·f_{D}>2M+3. This requirement may be achieved by appropriate choice of the pre-filter option and the value f_{D}. So, the matrix A in Equation (16) is rectangular and has dimension (T_{S}·f_{D}×2M+3). Equation (16) can be solved by an orthogonal expansion method or by the least squares method with the transition to the equivalent system (A^{T}×A)·y=(A^{T}×B). Both methods lead to almost the same solution. If the matrix A is built strongly according to requirements above, then solution the system 100 allows us to achieve, practically, an ideal cleaning of signal from noise at the arbitrary low signal-to-noise ratio

$${h}_{n} = \frac{{E}_{b}}{No} .$$

Some practical examples for hₙ=0.1 are considered infra.

The primary way to achieve results, which are impossible using the traditional OCR method, is hidden into structure and properties of the matrix which is a Linear Separating Matrix (LSM) 140. As illustrated in FIG. 6, the LSM is of a two-part construction. The first part is a signal part, which contains columns number 1 and 2 of the matrixes A . Column 1 contains measurements of the form-factor of the PSK-m or APSK-m cosine quadrature xcF(t) after passing through the LPF, and column 2 has similar measurements for sinus quadrature xsF(t). The influence of these columns to the signal-noise mixture is comparable with the work of a magnet that pulls the signal quadrature coefficients from the “garbage” created by noise.

The second part is a noise part, which contain all of the rest columns of the LSM. Each of the rows of the noise part contain values of harmonic functions of the noise's Fourier decomposition. These values were calculated for sampling moments. The influence of the noise's part is comparable with the work of a vacuum cleaner, which collects all of noise components cleaning the signal from “garbage”. So, both the “magnet” as well as the “vacuum cleaner” provide a separation process. Using estimates of y₀=a′ and y₁=b′ is enough to make a decision about the real value of the bits block. Using founded values of the variables y₂, y₃, . . . y_{2M+2} y, it is possible to recover the noise realization, as shown in the FIG. 6, by approximation with help of Fourier decomposition. This realization may contain signals for other customers.

### EXAMPLE 1

### PSK-4 Processing by SNS-Method Using LPF

The following signal and noise parameters with the same values as in processing by the OCR system and method discussed supra are as follows: signal-to noise ratio

$${h}_{n} = \frac{{E}_{b}}{No} = 0.1 ;$$

signal carrier frequency F_{C}=20 Hz; signal duration T_{S}=0.1 s.; number of signal points on the phase plane and the minimum difference angle m=4,

$$Δφ = \frac{2 π}{4} ;$$

signal initial phase

$${φ}_{0} = \frac{π}{10} ;$$

boundaries of the noise spectrum FL=0, FH=1000 Hz; and period of the noise decomposition TN=3 s.

To realize of linear analog LPF (see FIG. 5) lowpass filter of order 8 is employed, which has the transfer function:

$$W ( s ) = {( \frac{1}{1 + s \cdot T} )}^{8} \qquad Equation ( 18 )$$

where T=0.005 is the time constant; s=j·ω=j·2πf—is the complex frequency or Laplace transform variable; ω is frequency in

$$\frac{radian}{second} ;$$

f is frequency in Hertz; and j denotes the imaginary unit.

The frequency response of the LPF described by Equation (18) can be calculated by the following expression:

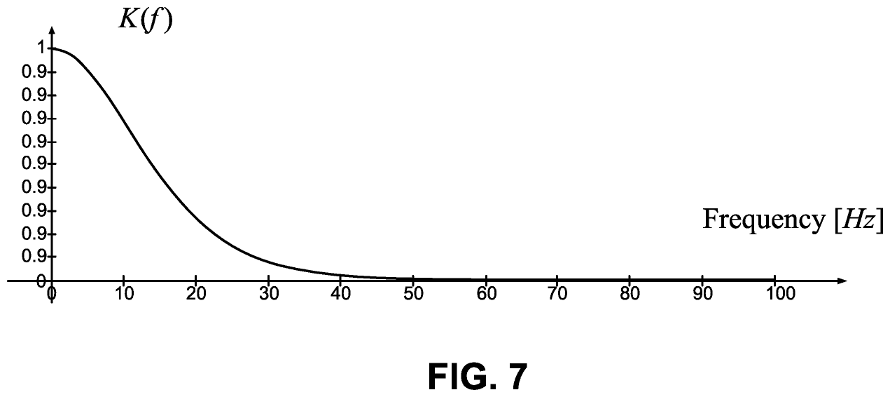

K(f)=|W(j·2πf)| Equation (19)
and has a frequency response shown in FIG. 7. For this LPF, we calculate the vector of the discreet amplitude values α to use it in noise model Equation (8) for implementation noise filtering process:

$${α}_{i} = K ( \frac{i}{TN} ) , i = FL , FL + 1 , … , TN \cdot FH . \qquad Equation ( 20 )$$

Since the LPF is an absolutely linear device, we have the right to consider signal and noise transformations by this filter separately (superposition principle). Finally, the overall response LPF on the signal-noise mixture is determined as the sum of these two responses.

Now we can describe the noise model Equation (8) after filtering by LPF next manner:

$$NF ( t ) = {\sum }_{i = TN \cdot FL}^{TN \cdot FH} {α}_{i} \cdot [ {nc}_{i} cos ( 2 π \frac{i}{TN} t ) + {ns}_{i} sin ( 2 π \frac{i}{TN} t ) ]$$

Taking of account phase changes when noise pass through LPF absolutely isn't needed. Because the random phases of frequency harmonics are defined by pairs of random coefficients of the same number ncᵢ and nsᵢ. Since these pairs of coefficients undergo exactly the same attenuation, and the phase of each harmonic with number i is determined by the arctangent of their ratio, the random distribution of phases of the noise components remains the same as in the noise model Equation (8).

Next is the description of the conversation of the PSK-4 signal when it passes through LPF (18). To describe the filtering process of the PSK-4 signal we'll use the method of operational calculus and apply Laplace transform. The pulse transfer characteristic w(t) of the LPF with transfer function W(s) from Equation (18) is determined by inverse Laplace transform of the W(s):

$$w ( t ) = {L}^{- 1} [ W ( s ) ] = \frac{{t}^{7}}{5040 \cdot {T}^{8}} exp ( - \frac{t}{T} ) , where T = 0.005 . \qquad Equation ( 22 )$$

Then the response of LPF on arbitrary input signal at zero initial conditions can be calculated by convolution integral.

$$xcF ( t ) = {\int }_{0}^{t} w ( τ ) \cdot xc ( t - τ ) d τ ; xsF ( t ) = {\int }_{0}^{t} w ( τ ) \cdot xs ( t - τ ) d τ . \qquad Equation ( 23 )$$

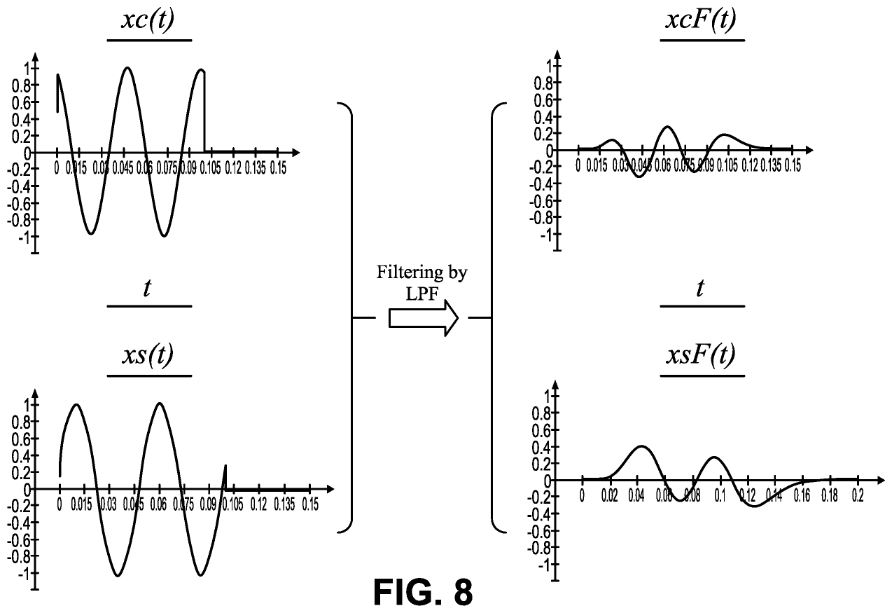

For this case of using LPF in Equation (18) for pre-filtering the transformations of PSK, APSK signals quadrature components xc(t)⇒xcF(t), xs(t)⇒xsF (t) are shown in the FIG. 8.

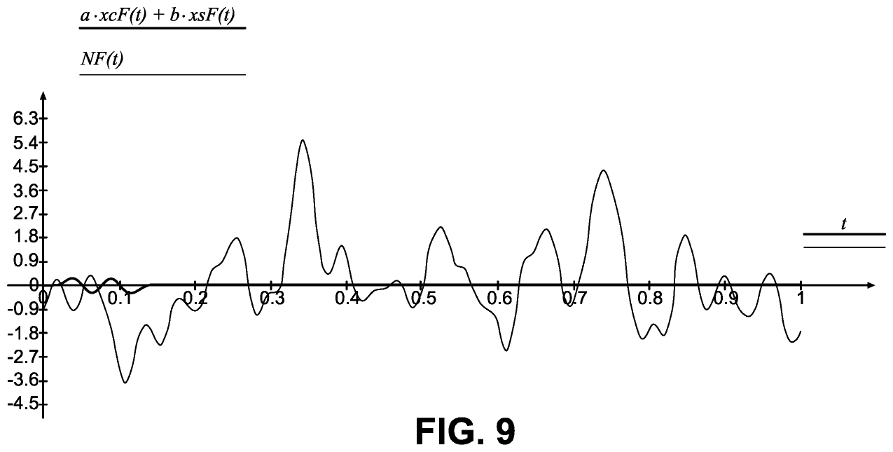

So, after filtering by LPF in Equation (18) the realizations of signal and noise observed at the LPF output are shown in the FIG. 9. And, the overall description of the mixture at the LPF output has view:

YF(t)=a·xcF(t)+b·xsF(t)+NF(t) Equation (24)

With accordance of the system 100, the next operation after filtering is sampling and quantizing mixture (24) by ADC YF(t)⇒YFq(t). This transformation has been described by Equation (15). For quantization signal-to-noise mixture estimation by Equation (15) we use the ADC bits deep nb=24. Analysis of the experiment conditions illustrated in the FIG. 7 and FIG. 9 allow defining the next parameters of the ADC and the Algebraic solver: D=8, M=300, d=1.1.

To construct the SLAE using Equations (16), (17) we choose the sampling frequency f_{D}=8000 Hz and define matrix components of the SLAE:

$$A = \vert {A}_{i , j} \vert , B = \vert {B}_{i} \vert , i = 0 , 1 , … , 8000 ; j = 0 , 1 , … , 2 M + 2.$$

$$\vert \begin{matrix}{A}_{i , 0} = xcF ( i / 8000 ) , {A}_{i , 1} = xsF ( i / 8000 ) , \\ {A}_{i , j} = cos ( 2 π \frac{j - 2}{d} \cdot \frac{i}{8000} ) , j = 2 , … , M + 2 , \\ {A}_{i , j} = sin ( 2 π \frac{j - M - 2}{d} \cdot \frac{i}{8000} ) , j = M + 3 , … , 2 M + 2 , \\ {B}_{i} = YFq ( \frac{i}{8000} )\end{matrix} \} i = 0 , … 8000. \qquad Equation ( 25 )$$

Defined by the matrix in Equation (25), A has dimension (8001×603) and redefinition factor

$$Rf = \frac{8001}{603} \approx 13.27 .$$

Such order of redefinition makes SLAE extra stable related to rounding errors and the quantization noise. This SLAE is totally linear. It means that the SNS-method only consists of linear operations, except digitizing, nonlinearity of which was taken into account in the Equation (15).

To test the SNS-method under conditions similar previous example for the known OCR-method, the computational statistical experiment has been performed. An each cycle of the experiment, a sequence of steps was performed: generation of 2(TN+1)·FN normally distributed random coefficients of noise ncᵢ and nsᵢ; generation of Gaussian noise implementation after passing it through LPF using filter weighted Fourier decomposition (as described in Equation (21)); using Equations (14) and (15), forming and digitizing an additive filtered signal PSK-4-to-noise mixture on the output of LPF; implementation of reception according to SNS method by construction and solving SLAE using Equation (25) with separation PSK-4 quadrature coefficients and coefficients of the noise decomposition; and writing values obtained estimates into the result table.

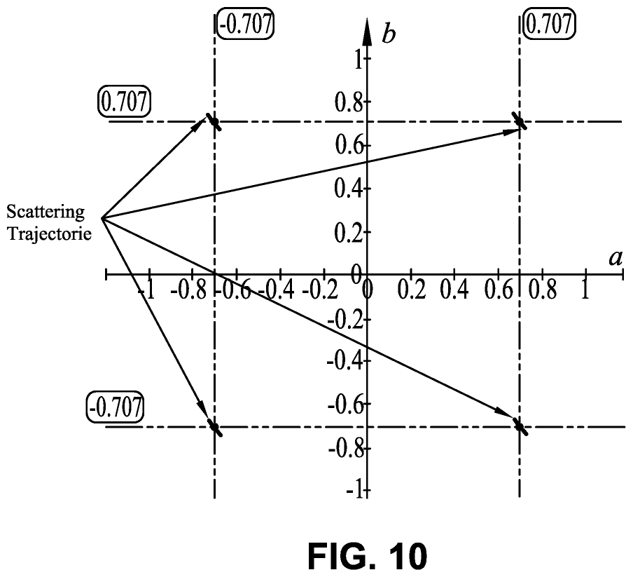

In the present experiment, the steps above were recited multiple times to collect statistics with enough volume. In FIG. 10 the scattering trajectories of the PSK-4 phase points after selection signal and noise by our SNS technology are shown. These trajectories are very short straight segments passing through the true positions of the PSK-4 phase points. The angle of crossing true points by scattering segments is defined by used signal initial phase

$${φ}_{0} = \frac{π}{10} .$$

The result in the FIG. 10 corresponds to 4000 experiments, where all possible 4 phase angles were used with the same number of times. The total number of transmitted bits was 8000 (two bits per one PSK-4 signal). Application of Equation (11) demonstrated that no bits were received in error.

BER_{SNS PSK-4}≡0 Equation (26)
This result is compared with that of Equation (13) obtained supra.

### EXAMPLE 2

### PSK-16 Processing by SNS-Method Using LPF

This example uses the same parameters of signal, noise, LPF of Equation (18) and S/N ratio as in Example 1, except for the m parameter: number of signal points on the phase plane and the minimum difference angle m=16,

$$Δφ = \frac{2 π}{16} .$$

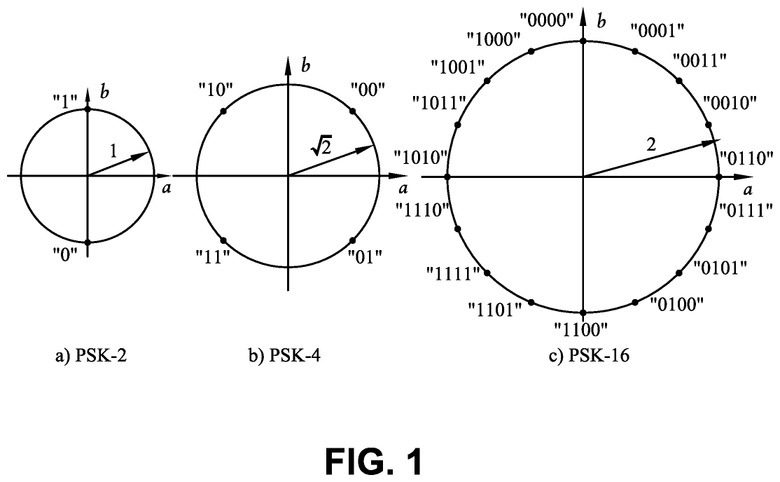

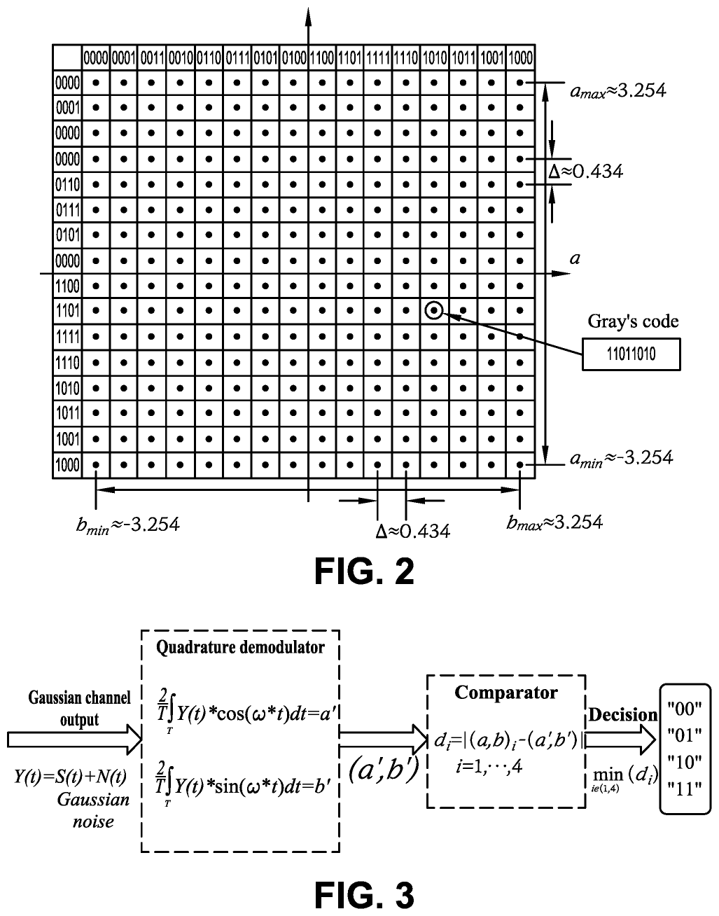

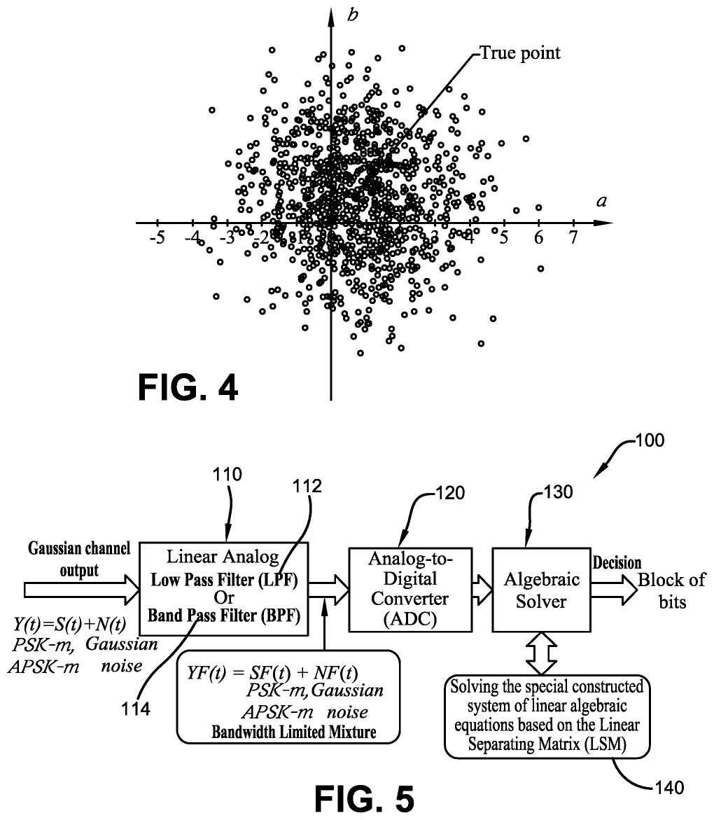

The disposition of signal points and Grey code corresponding there are shown in the FIG. 1(c). Each elementary signal within one modulation interval carriers 4 bits of information. It should be noted that well-known OCR-method under these conditions gives a huge spread in the estimates of the received signal points (see, for example, FIG. 4). So, if we take into account the properties of the Gray code used, and testing results, then we can state:

BER_{OCR PSK-16}=0.375 Equation (27)

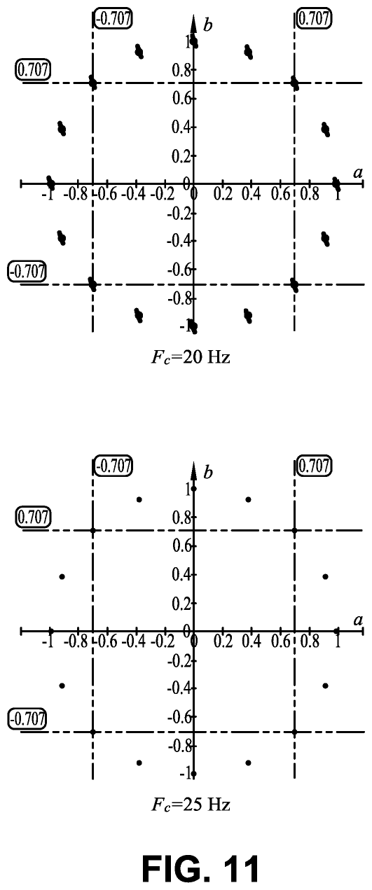

Statistical verification of the developed SNS-method for processing of the PSK-16 gives results shown in FIG. 11. FIG. 11(a) illustrates that there is still a very small scatter estimates of signal points coordinates in the ranges of trajectories in the form of short straight segments having a certain slope in accordance with the value of initial phase

$${ω}_{0} = \frac{π}{10} .$$

If we slightly change the signal parameters, namely the carrier frequency F_{C}=25 Hz and initial phase

$${ω}_{0} = \frac{π}{7} .$$

(FIG. 11(b), then this scattering, practically, disappears. The total numbers of transmitted signals (for both cases shown in the FIG. 11) is 1600. That is, in both cases, 6400 bits were transmitted. Application of the Equation (11) shows there are absolutely no erroneous bits in the experiment:

BERS_{SNS PSK-16}≡0 Equation (28)
A comparison of Equations (27) and (28) shows an unconditional advantage of using the present SNS-method.

### EXAMPLE 3

### APSK-256 Processing by SNS-Method Using BPF

In this example, we made changes of type and parameters of signal to realize the model shown in the FIG, 2. Here, m=256, F_{C}=95 Hz,

$${ω}_{0} = \frac{π}{4} ,$$

but the noise model and its parameters are unchanged. Such signal is able to transmit 8 bits per one modulation interval. The absolute data rate is incised by 4 times compared PSK-4 and 2 times with PSK-16. To suppress the out-band frequencies in the signal-noise mixture spectrum, the bandpass filter 110 is used as the linear analog pre-filter (see FIG. 4). First, an analytic description of the linear BPF 114 is obtained to ensure that the experiment is repeatable. The selected order of the filter 114 is equal to 8 and the filter 114 is built based on a cascade of 4 oscillatory circuits of the 2nd order with the same time constant T. The transfer function of such BPF is:

$$W ( s ) = \frac{1}{\begin{matrix}{T}^{8} \cdot ( {s}^{2} + {α}_{1} s + δ ) ( {s}^{2} + {α}_{2} s + δ ) \\ ( {s}^{2} + {α}_{3} s + δ ) ( {s}^{2} + {α}_{4} s + δ )\end{matrix}} . \qquad Equation ( 29 )$$

Here used next denotes:

$${α}_{1} = \frac{2 {ξ}_{1}}{T} , {α}_{2} = \frac{2 {ξ}_{2}}{T} , {α}_{3} = \frac{2 {ξ}_{3}}{T} , {α}_{4} = \frac{2 {ξ}_{4}}{T} , δ = \frac{1}{{T}^{2}} , \\ T = \frac{1}{2 π {f}_{r}} \qquad Equation ( 30 )$$

where fᵣ is the resonance frequency; and ξ₁ . . . ξ₄ is attenuation coefficients ranged from 0 to 1.

To find the impulse response of the BPF 114 we will obtain an inverse Laplace transformation of the transfer function of Equation (29). To do this, we apply the operates method based on the representation of function of Equation (29) as a sum of simple rational fractions:

$${W}_{BPF} ( s ) = \frac{1}{{T}^{8}} \{ \frac{{A}_{1} s + {B}_{1}}{( {s}^{2} + {a}_{1} s + b )} + \frac{{A}_{2} s + {B}_{2}}{( {s}^{2} + {α}_{2} s + b )} + \frac{{A}_{3} s + {B}_{3}}{( {s}^{2} + {a}_{3} s + b )} + \frac{{A}_{4} + {B}_{4}}{( {s}^{2} + {a}_{4} s + b )} \} \qquad Equation ( 31 )$$

where A₁ . . . A₄; B₁ . . . B₄ are as yet indefinite multipliers. They are defined below.

Next, using the table of mutual correspond between Laplace images and the time functions originals of Equation (10), we can write expression for the desired impulse response of BPF:

$${w}_{BPF} ( t ) = \frac{1}{{T}^{8}} {\sum }_{k = 1}^{4} \{ {A}_{k} cos ( t \sqrt{δ - \frac{{α}_{k}^{2}}{4}} ) + \frac{{B}_{k} - {A}_{k} \frac{{α}_{k}}{2}}{\sqrt{δ - \frac{{α}_{k}^{2}}{4}}} sin ( t \sqrt{δ - \frac{{α}_{k}^{2}}{4}} ) \} \cdot {e}^{- \frac{{α}_{k}}{2} t} . \qquad Equation ( 32 )$$

To define A₁ . . . A₄; B₁ . . . B₄ the indefinite multipliers method is used. The parenthesized expression in Equation (3) is brought to a common denominator. After simplification, the following list of coefficients at the powers of complex variable presented in Table 1 below. Next the construct system of equations is created by equating the coefficients at the same powers of the variable s in the numerators of fractions in Equations (29) and (31). Coefficients of in Equation (31) are placed in the Table 1. In the numerator in Equation (29) all coefficients except zero degree are equal to 0. So, the system of linear equations for finding indefinite multipliers A₁ . . . A₄; B₁ . . . B₄ has the view presented by the expressions in Equation (33).

TABLE 1
Coefficients at the powers of Laplace transform variable.

| | |
|---|---|
| s⁷ | A₁ + A₂ + A₃ + A₄ |
| s⁶ | A₁ (α₂ + a₃ + a₄) + A₂ (α₁ + α₃ + α₄) + A₃ (α₁ + α₂ + α₄) + A₄ (α₁ + α₂ + α₃) + B₁ + B₂ + B₃ + B₄ |
| s⁵ | A₁ (3δ + α₂α₃ + α₂a₄ + α₃α₄) + A₂ (3δ + α₁α₃ + α₁α₄ + α₃α₄) + A₃ (3δ + α₁α₂ + α₁α₄ + α₂α₄) + + |
| | A₄ (3δ + α₁α₂ + α₁α₃ + α₂α₃) + B₁ (α₂ + α₃ + α₄) + B₂ (α₁ + α₃ + α₄) + B₃ (α₁ + α₂ + α₄) + + |
| | B₄ (α₁ + α₂ + α₃) |
| s⁴ | A₁ (1 + 2δ)α₂α₃α₄ + A₂ (1 + 2δ)α₁α₃α₄ + A₃ (1 + 2δ)α₁α₂α₄ + A₄ (1 + 2δ)α₁α₂α₃ + + |
| | B₁ (3δ + α₂α₃ + α₂α₄ + α₃α₄) + B₂ (3δ + α₁α₃ + α₁α₄ + α₃α₄) + + |
| | B₃ (3δ + α₁α₂ + α₁α₄ + α₂α₄) + B₄ (3δ + α₁α₂ + α₁α₃ + α₂α₃) |
| s³ | A₁b (3δ + α₂α₃ + α₂α₄ + α₃α₄) + A₂b (3δ + α₁α₃ + α₁α₄ + α₃α₄) + A₃b (3δ + α₁α₂ + α₁α₄ + α₂α₄) + + |
| | A₄ (3δ + α₁α₂ + α₁α₃ + α₂α₃) + B₁ (1 + 2δ)α₂α₃α₄ + B₂ (1 + 2δ)α₁α₃α₄ + B₃ (1 + 2δ)α₁α₂α₄ + + |
| | B₄ (1 + 2δ)α₁α₂α₃ |
| s² | A₁δ² (α₂ + α₃ + α₄) + A₂δ² (α₁ + α₃ + α₄) + A₃δ² (α₁ + α₂ + α₄) + A₄δ² (α₁ + α₂ + α₃) + + |
| | B₁δ (3δ + α₂α₃ + α₂α₄ + α₃α₄) + B₂δ (3δ + α₁α₃ + α₁α₄ + α₃α₄) + B₃δ (3δ + α₁α₂ + α₁α₄ + α₂α₄) + + |
| | B₄δ (3δ + α₁α₂ + α₁α₃ + α₂α₃) |
| s¹ | δ³ (A₁ + A₂ + A₃ + A₄) + B₁δ² (α₂ + α₃ + α₄) + B₂δ² (α₁ + α₃ + α₄) + B₃δ² (α₁ + α₂ + α₄) + + |
| | B₁δ² (α₁ + α₂ + α₃) |
| s⁰ | δ³ (B₁ + B₂ + B₃ + B₄) |

$$\{ \begin{matrix}{A}_{1} + {A}_{2} + {A}_{3} + {A}_{4} = 0 \\ \begin{matrix}{A}_{1} ( {a}_{2} + {a}_{3} + {a}_{4} ) + {A}_{2} ( {a}_{1} + {a}_{3} + {a}_{4} ) + {A}_{3} ( {a}_{1} + {a}_{2} + {a}_{4} ) + {A}_{4} ( {a}_{1} + {a}_{2} + {a}_{3} ) + {B}_{1} + {B}_{2} + {B}_{3} + {B}_{4} = 0 \\ {A}_{1} ( 3 b + {a}_{2} {a}_{3} + {a}_{2} {a}_{4} + {a}_{3} {a}_{4} ) + {A}_{2} ( 3 b + {a}_{1} {a}_{3} + {a}_{1} {a}_{4} + {a}_{3} {a}_{4} ) + {A}_{3} ( 3 b + {a}_{1} {a}_{2} + {a}_{1} {a}_{4} + {a}_{2} {a}_{4} ) +\end{matrix} \\ {A}_{4} ( 3 b + {a}_{1} {a}_{2} + {a}_{1} {a}_{3} + {a}_{2} {a}_{3} ) ++ {B}_{1} ( {a}_{2} + {a}_{3} + {a}_{4} ) + {B}_{2} ( {a}_{1} + {a}_{3} + {a}_{4} ) + {B}_{3} ( {a}_{1} + {a}_{2} + {a}_{4} ) + {B}_{4} ( {a}_{1} + {a}_{2} + {a}_{3} ) = 0 \\ {A}_{1} ( 1 + 2 b ) {a}_{2} {a}_{3} {a}_{4} + {A}_{2} ( 1 + 2 b ) {a}_{1} {a}_{3} {a}_{4} + {A}_{3} ( 1 + 2 b ) {a}_{1} {a}_{2} {a}_{4} + {A}_{4} ( 1 + 2 b ) {a}_{1} {a}_{2} {a}_{3} + {B}_{1} ( 3 b + {a}_{2} {a}_{3} + {a}_{2} {a}_{4} + {a}_{3} {a}_{4} ) ++ \\ {B}_{2} ( 3 b + {a}_{1} {a}_{3} + {a}_{1} {a}_{4} + {a}_{3} {a}_{4} ) + {B}_{3} ( 3 b + {a}_{1} {a}_{2} + {a}_{1} {a}_{4} + {a}_{2} {a}_{4} ) + {B}_{4} ( 3 b + {a}_{1} {a}_{2} + {a}_{1} {a}_{3} + {a}_{2} {a}_{3} ) = 0 \\ {A}_{1} b ( 3 b + {a}_{2} {a}_{3} + {a}_{2} {a}_{4} + {a}_{3} {a}_{4} ) + {A}_{2} b ( 3 b + {a}_{1} {a}_{3} + {a}_{1} {a}_{4} + {a}_{3} {a}_{4} ) + {A}_{3} b ( 3 b + {a}_{1} {a}_{2} + {a}_{1} {a}_{4} + {a}_{2} {a}_{4} ) + \\ {A}_{4} ( 3 b + {a}_{1} {a}_{2} + {a}_{1} {a}_{3} + {a}_{2} {a}_{3} ) ++ {B}_{1} ( 1 + 2 b ) {a}_{2} {a}_{3} {a}_{4} + {B}_{2} ( 1 + 2 b ) {a}_{1} {a}_{3} {a}_{4} + {B}_{3} ( 1 + 2 b ) {a}_{1} {a}_{2} {a}_{4} + {B}_{4} ( 1 + 2 b ) {a}_{1} {a}_{2} {a}_{3} = 0 \\ {A}_{1} {b}^{2} ( {a}_{2} + {a}_{3} + {a}_{4} ) + {A}_{2} {b}^{2} ( {a}_{1} + {a}_{3} + {a}_{4} ) + {A}_{3} {b}^{2} ( {a}_{1} + {a}_{2} + {a}_{4} ) + {A}_{4} {b}^{2} ( {a}_{1} + {a}_{2} + {a}_{3} ) + {B}_{1} b ( 3 b + {a}_{2} {a}_{3} + {a}_{2} {a}_{4} + {a}_{3} {a}_{4} ) + \\ {B}_{2} b ( 3 b + {a}_{1} {a}_{3} + {a}_{1} {a}_{4} + {a}_{3} {a}_{4} ) + {B}_{3} b ( 3 b + {a}_{1} {a}_{2} + {a}_{1} {a}_{4} + {a}_{2} {a}_{4} ) + {B}_{4} b ( 3 b + {a}_{1} {a}_{2} + {a}_{1} {a}_{3} + {a}_{2} {a}_{3} ) = 0 \\ {b}^{3} ( {A}_{1} + {A}_{2} + {A}_{3} + {A}_{4} ) + {B}_{1} {b}^{2} ( {a}_{2} + {a}_{3} + {a}_{4} ) + {B}_{2} {b}^{2} ( {a}_{1} + {a}_{3} + {a}_{4} ) + {B}_{3} {b}^{2} ( {a}_{1} + {a}_{2} + {a}_{4} ) + {B}_{1} {b}^{2} ( {a}_{1} + {a}_{2} + {a}_{3} ) = 0 \\ {b}^{3} ( {B}_{1} + {B}_{2} + {B}_{3} + {B}_{4} ) = 1\end{matrix} \qquad Equation ( 33 )$$

Substitution of the values of the selected attenuation coefficient

ξ₁=0.4, ξ₂=0.2, ξ₃=0.08, ξ₄=0.04 Equation (34)
into expressions of Equations (29), (30) and calculation

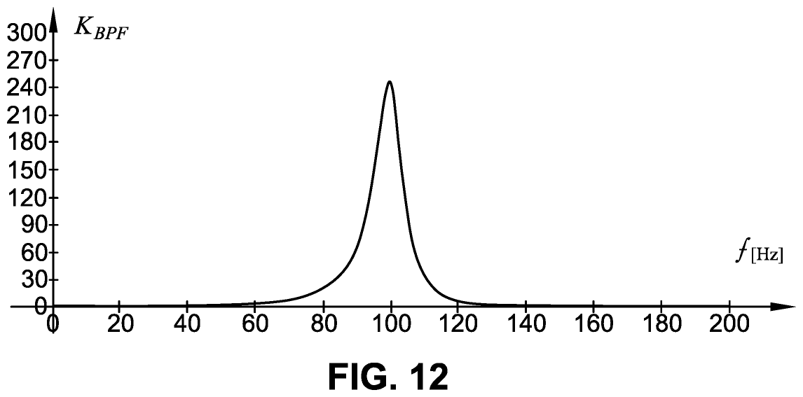

K_{BPF}(f)=|W_{BPF}(j·2πf)| Equation (35)
gives frequency response of the BPF 114 shown in FIG.12.

Solution of the system of Equation (33) at the values of Equation (34) gives:

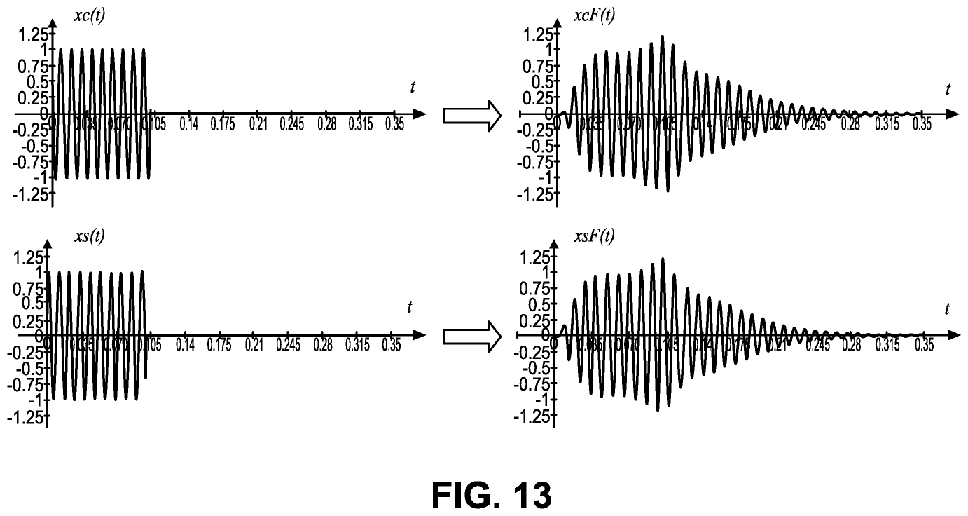

A₁=8.981509·10⁻²⁰; A₂=−1.347234·10⁻¹⁹; A₃=5.389161·10⁻²⁰; A₄=−8.983268·10⁻²¹; B₁=−9.593503·10⁻¹⁷; B₂=3.893834·10⁻¹⁶; B₃=−4.178253·10⁻¹⁶; B₄=1.406295·10⁻¹⁶. Equation (36)
So, substitution of defined values in Equation (36) into Equation (32) and calculations of the convolution integrals give a possibility to define the signal transformations after BPF passing.

$$xcF ( t ) = Kr \cdot {\int }_{0}^{t} {w}_{BPF} ( τ ) \cdot xc ( t - τ ) d τ ; \\ xsF ( t ) = Kr \cdot {\int }_{0}^{t} {w}_{BPF} ( τ ) \cdot xs ( t - τ ) d τ \qquad Equation ( 37 )$$

where Kr=0.05 is the resonant amplification compensation factor. BPF conversions of Equation (37) of the quadrature components of the AFSK-256 signal are illustrated in FIG. 13.

Pre-filtering of the noise, which described by decomposition in Equation (8), can be calculated on the base using frequency response of BPF in Equation (35):

$$N F ( t ) = K r \cdot \text{} {\sum }_{i = T N \cdot F L}^{T N \cdot F N} \{ {K}_{BPF} ( \frac{i}{TN} ) \cdot [ n {c}_{i} \cdot cos ( 2 π \frac{i}{T N} t ) + {ns}_{i} \cdot sin ( 2 π \frac{i}{T N} t ) ] \} \qquad Equation ( 38 )$$

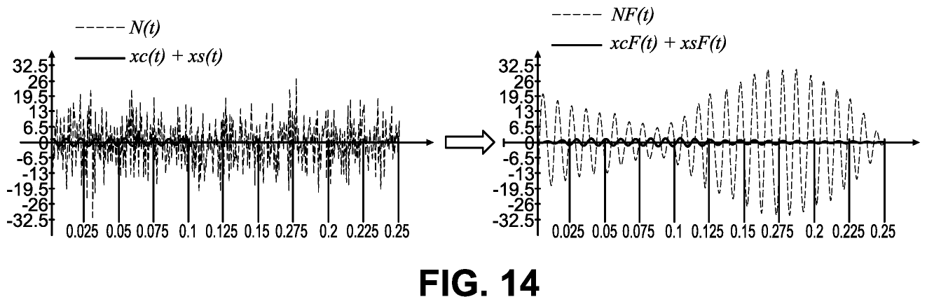

FIG. 14 illustrates noise realization and form-factor of the signal AFSK-256 after pre-filtering BPF. Digitizing of the signal-noise mixture after prefiltering, constructing and solution the SLAE of Equation (25), when parameters

$${φ}_{0} = \frac{π}{4} ,$$

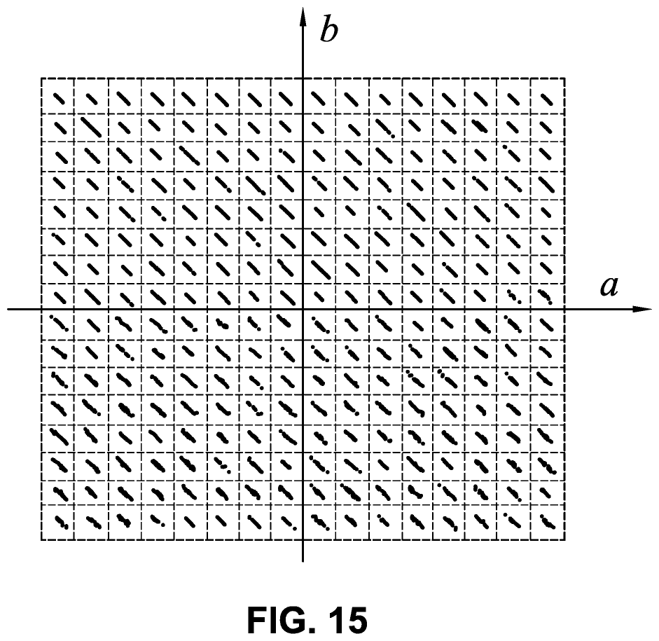

M=500, f_{D}=8000, gave the results shown in the FIG. 15. As it was before, spreading of the signal points positions estimates has trajectories a short straight segment, which cross the true F points. Not one erroneous bit was observed. The experiment used a full set of the APSK-256 signal points. 5120 signal-noise mixture implementations were processed, that corresponds to transmitting 40960 bits. Therefore, we can state:

BEK_{SNS APSK-256}≡0 Equation (39)

It is important to note that OCR-method under the same conditions has the result.

BER_{OCR APSK-256}≈0.415 Equation (40)

To compare the OCR and the SNS-methods of receiving of the present invention, two specific indexes are used, which allows performing a comparison of different systems in universal conditions. The first is the index of specific energy effectiveness,

$$β = \frac{R}{{h}_{n}} . \qquad Equation ( 41 )$$

where R is amount of information, which contains each of binary symbol at the receiver output;

$${h}_{n} = \frac{{E}_{b}}{No}$$

is the signal-to noise ratio. E_{b} is the transmitter's energy spent on the transmission of one bit; and No is the spectral noise density of the AWGN. The physical sense of the index in Equation (41) is transmission rate per unit of signal-to noise ratio.

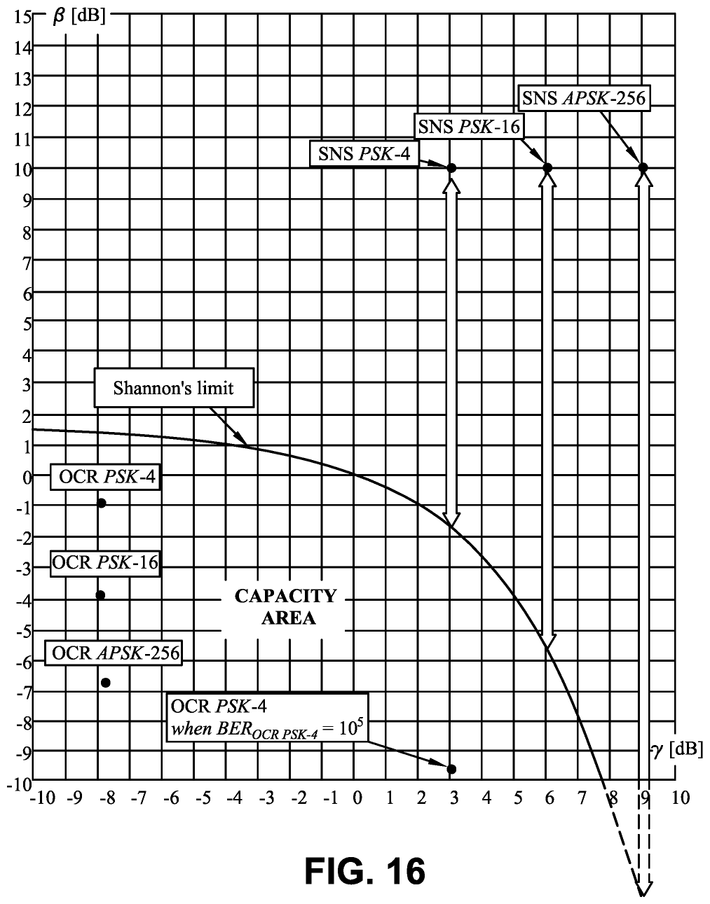

The second is the index of specific frequency effectiveness,

$$γ = \frac{R}{F} . \qquad Equation ( 42 )$$

where F is a frequency band of a signal. The physical sense of the index of Equation (42) is transmission rate per one Hertz of a frequency band. Usually relies, that signal with duration 1 second occupies 1 Hz of band. The indexes of Equations (41) and (42) usually uses as coordinates of effectiveness plane, where apply a logarithmic scale (in decibels). The example of such plane is shown in the FIG. 16 for illustration of our achieved benefits for conditions which were described. The display points of more effectiveness systems are on the efficiency plane to the right (more specific rate in the frequency band) and higher (less specific energy costs for transmission).

Using Shannon's Capacity definition of Equations [6÷8], we can to obtain the interconnection between indexes in Equations (41) and (42):

$$β = \frac{γ}{{2}^{γ} - 1} \qquad Equation ( 43 )$$

This dependence is shown on the effectiveness plane as, so called, “Shannon's limit”. This now dominates the erroneous postulate that the Shannon's limit defines the curve of the best mutual exchange between energy and frequency effectiveness, and the display points corresponding to physically realizable systems can be located exclusively below this curve (Capacity area illustrated in FIG. 16). The current accepted theory erroneously asserts that there can be no systems whose representative points lie above Shannon's absolute limit. This erroneous statement is consequence of the misconception that optimal coherent reception (OCR) method is the best way for receiver working. The present invention completely refutes this statement. The category CAPASITY was obtained under assumption, that OCR is the best method in Equations [1÷7]. This erroneous basis leaded to the erroneous limit. The present invention of the SNS-method of the signal processing (PSK-4, PSK-16, APSK-256) refutes this fallacy.

There are seven points shown in FIG. 16. The point of the OCR PSK-4 calculated when BER_{OCR PSK-4}=10⁻⁵. This point usual is considered as a start point to compare with other systems, and has the coordinates: β₁=−9.6 [dB] γ₁=3 [dB]. The point of the OCR-PSK-4 calculated under conditions, described above, when hₙ=0.1 and has the coordinates: β₂=0.83 [dB] γ₂=−7.823 [dB]. The point of the OCR-PSK-16 calculated under conditions, described above, when hₙ=0.1 and has the coordinates: β₃=−3.9 [B] γ₃=−7.9 [dB]. The point of the OCR-APSK-256 calculated under conditions, described above, when hₙ=0.1 and has the coordinates: β₄=−6.7 [dB] γ₃=−7.6 [dB]. These points are situated below Shannon's limit into the Capacity area. The OCR-method cannot exceed the Capacity, because the very large values of the BER lead to the decreasing of the rate R, which presents in nominators of indicators in Equations (41) and (42). Also, the point of the SNS PSK-4 calculated when hₙ=0.1 and has the coordinates: β₅=10 [dB] γ₅=3 [dB]. The point of the SNS PSK-16 calculated when hₙ=0.1 and has the coordinates: β₆=10 [B] γ₃=6 [dB]. The point of the SNS APSK-256 calculated when hₙ=0.1 and has the coordinates: β₇=10 [dB] γ₃=9 [dB].

All of the displayed points of the present SNS-method exceed the Capacity: point 5 onto 12 dB (16 times); point 6 onto 16 dB (40 times); point 7 onto 24 dB (150 times). So, developed in this invention, the SNS-method and system 100 exceeded the Capacity limit not less onto 10-100 times.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for achieving a signal and noise separation in a phase-shift keyed signal comprising:
a linear analog filter;
an analog to digital converter;
a solver-separator component in communication with the linear analog filter and the analog to digital converter; and
wherein the linear analog filter is configured to accept a signal to noise mixture via a channel with noise and send a modified signal to noise mixture to the solver-separator component for completing a clean separation of signal and noise.

2. The system of claim 1, wherein the noise is an interference in a channel or a communication line.

3. The system of claim 1, wherein the linear analog filter is a low pass filter.

4. The system of claim 1, wherein the linear analog filter is a band pass filter.

5. The system of claim 1, wherein the analog to digital converter is configured to filter the signal to noise mixture at a sampling rate of f_{D} per second.

6. The system of claim 1, wherein the solver-separator component is configured to solve a system of linear algebraic equations based on a linear separating matrix.

7. The system of claim 6, wherein the linear separating matrix comprises a signal part and a noise part.

8. The system of claim 1, wherein the signal to noise mixture is pre-filtered to remove out-of-band noise frequencies prior to entering the linear analog filter.

9. A system for achieving a signal and noise separation in an amplitude-phase modulated signal comprising:
a linear analog filter;
an analog to digital converter;
a solver-separator component in communication with the frequency preprocessing component and the analog to digital converter; and
wherein the linear analog filter is configured to accept a signal to noise mixture via a channel with noise and send a modified signal to noise mixture to the solver-separator component for completing a clean separation of signal and noise.

10. The system of claim 9, wherein the noise is an interference in a channel or a communication line.

11. The system of claim 9, wherein the linear analog filter is a low pass filter.

12. The system of claim 9, wherein the linear analog filter is a band pass filter.

13. The system of claim 9, wherein the analog to digital converter is configured to filter the signal to noise mixture at a sampling rate of f_{D} per second.

14. The system of claim 9, wherein the solver-separator component is configured to solve a system of linear algebraic equations based on a linear separating matrix.

15. The system of claim 14, wherein the linear separating matrix comprises a signal part and a noise part.

16. The system of claim 9, wherein the signal to noise mixture is pre-filtered to remove out-of-band noise frequencies prior to entering the linear analog filter.

17. A method of achieving a clean signal and noise separation in phase-shift keyed and amplitude-phase modulated signals, the method comprising:
providing a Gaussian channel noise;
suppressing a spectrum of noise in the phase-shift keyed and amplitude-phase modulated signals with a linear analog filter;
quantizing a signal-noise mixture using an analog to digital converter;
sending a modified signal to noise mixture to a solver-separator component;
using discrete measurements of the modified signal to noise mixture to build a system of linear algebraic equations;
using a linear separating matrix of coefficients to achieve a clean separation of signal and noise.

18. The method of claim 17 further comprising suppressing out-of-band noise frequencies prior to entering the linear analog filter.

19. The method of claim 17, wherein the linear analog filter is a low pass filter or a band pass filter.

20. The method of claim 17, wherein the solver-separator component is configured to solve a system of linear algebraic equations based on a linear separating matrix.
